(19) United States
(12) Patent Application Publication
(10) Pub. No.: US 2010/0075032 A1
(43) Pub. Date: Mar. 25, 2010

(54) POROUS FILM PRODUCTION METHOD AND APPARATUS

(75) Inventors: Koju ITO, Kanagawa (JP); Hidekazu Yamazaki, Kanagawa (JP)

Correspondence Address: YOUNG & THOMPSON, 209 Madison Street, Suite 500, Alexandria, VA, 22314, US

(73) Assignee: FUJIFILM Corporation, Tokyo (JP)

(21) Appl. No.: 12/565,149

(22) Filed: Sep. 23, 2009

(30) Foreign Application Priority Data
Sep. 24, 2008 (JP) 2008-243641

(51) Int. Cl. B05D 5/00; B05C 11/00

(52) U.S. Cl. 427/243; 118/68

(57) ABSTRACT

A coating die has a discharge port for discharging a solution. A chamber has an opening. The coating die and chamber are disposed such that the discharge port and the opening are close to a support moving in an X direction. The solution is discharged through the discharge port. The discharged solution is applied to a surface of the support as a coating film. Wet air having parameters ΔTw and ΔTsolv adjusted to a predetermined range is blown through the opening to the discharged solution. The wet air contacts the solution so water vapor condenses on the surface of the solution to generate water drops. While the water drops grow up, a solvent is evaporated from the solution actively. The growth of cores of the water drops is prevented at an early stage by utilizing a decrease in fluidity of the solution due to the evaporation of the solvent.

### FIELD OF THE INVENTION

The present invention relates to a method and an apparatus for producing a porous film.

### BACKGROUND OF THE INVENTION

In recent years, increase in integration degree, higher information density, and higher image definition have been desired more and more in the fields of optics and electronics. Therefore, a film used in these fields is strongly required to have a finer structure. Namely, forming a fine pattern structure (fine patterning) has been strongly required. Additionally, in a field of research for a regenerative medicine, a film having a surface with the fine structure is effectively used as a scaffold for cell culture.

Various methods for the fine pattering of films have been put to practical use. For example, there are a deposition method using a mask, an optical lithography adopting photochemical reaction and polymerization reaction, a laser ablation technique, and the like.

In addition to the above, as the fine pattering of films, there is known a method, in which a polymer solution is applied to a support to be a coating film, and wet air is blown to the coating film to form a porous film (for example, see Japanese Patent Laid-Open Publications No. 2001-157574 and No. 2007-291367). An outline of the porous film production method is briefly described hereinbelow. At first, a solution containing a hydrophobic solvent and a polymer is discharged onto a support by a discharge device to form a coating film on the support. Next, under the atmosphere in which temperature, dew point, and the like are adjusted, the solvent contained in the coating film is evaporated, and water vapor is condensed from ambient air on an exposed surface of the coating film to generate water drops. The water drops are grown up. The water drops on the exposed surface enter the inside of the coating film while keeping its size or growing up. When fluidity of the coating film is decreased due to the evaporation of the solvent, a primary form having a plurality of pores can be obtained using the water drops as a template for a porous film. Finally, dry air is blown to the primary form to evaporate the water drops therefrom. Accordingly, the porous film can be obtained.

It is known that the pore size and pore density in the porous film obtained by the methods described above are influenced by the amount of cores of the water drops and the growth degree of cores of the water drops throughout the manufacturing process. Further, it is known that the amount of cores of the water drops and the growth degree of cores of the water drops can be controlled by appropriately adjusting a parameter ΔTw obtained by subtracting TS from TD in which TS is a temperature of the exposed surface and TD is a dew point of the air around the exposed surface. Under a condition that the parameter ΔTw is appropriately adjusted, water drops are generated and grown up on the exposed surface. Accordingly, it is possible to achieve a desired size and a desired density of the pores in the porous film finally obtained.

However, even if the parameter ΔTw is adjusted, troubles such as variation in size and density of the pores in the porous film (hereinafter referred to as variation trouble) occur. As a result of keen examination of an inventor, it was found that the variation trouble arises from a behavior of the solution discharged from the discharge device.

The behavior of the solution arises from a free surface of the solution. The solution discharged from the discharge device has the free surface. The solution having the free surface likely causes a disturbance inducing the variation trouble by the free surface. As the disturbance inducing the variation trouble, there are variation in the viscosity of the solution, convection of the solution, thickness unevenness of a bead, variation in the humidity of the atmosphere at the vicinity of the free surface, unevenness in evaporation of the solvent on the free surface, convection of the atmosphere at the vicinity of the free surface, change in the proportion between a moving speed of the support and the discharge amount of the solution, and the like.

As a method for sufficiently preventing such a variation trouble, a wind shielding member may be disposed at the vicinity of a discharge port of the discharge device. However, it is not possible to sufficiently prevent the variation trouble by the above method, and therefore there is a limit in the above method.

### SUMMARY OF THE INVENTION

In view of the above, an object of the present invention is to provide a method and an apparatus for producing a porous film having pores of a desired size while preventing variation troubles.

In order to achieve the above and other objects, a porous film production method of the present invention includes the following steps. A solution containing a polymer and a hydrophobic solvent is discharged onto a moving support by a discharge device. Wet air is caused to contact with the discharged solution between the discharge device and the support. The solution reaches the support to be a film. Water vapor is condensed from ambient air by the contact of the wet air and the solution to generate water drops. The film is dried such that the film has pores made by the water drops as a template for a porous film.

Preferably, the wet air is caused to contact with an upstream end of a free surface of the discharged solution between the discharge device and the support. Further, the solution may be discharged in an atmosphere filled with the wet air. Furthermore, the wet air may be continuously caused to contact with the free surface of the solution until the solution becomes the film. The discharge device is preferably a coating die.

A porous film production apparatus of the present invention includes a moving support, a discharge device, a wet air contacting device, and a drying device. The discharge device discharges a solution containing a polymer and a hydrophobic solvent onto the support. The solution reaches the support to be a film. The wet air contacting device causes wet air to contact with the discharged solution between the discharge device and the support. The drying device dries the film whose surface has water drops generated by water vapor condensed from ambient air, such that the film has pores made by the water drops as a template for a porous film.

It is preferable that the discharge device has a die for discharging the solution onto the support, and the wet air contacting device has a humidifying chamber disposed in a downstream side from the die in a moving direction of the support.

According to the present invention, since the wet air is caused to contact with the bead formed from the solution discharged by the discharge device so as to extend from the discharge device to the support, it is possible to avoid variation trouble caused by the behavior of the solution. Thus, according to the present invention, it is possible to produce a porous film in which the pores having a specific size are arranged such that the pore density is uniform.

### DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1A is a plan view schematically illustrating a porous film including a plurality of through holes, FIG. 1B is a cross sectional view taken along chain double-dashed lines B-B of FIG. 1A, FIG. 1C is a cross sectional view taken along chain double-dashed lines C-C of FIG. 1A, and FIG. 1D is a cross sectional view illustrating a porous film on which a plurality of dimples are formed;

FIG. 2 is an explanatory view schematically illustrating a porous film production apparatus;

FIG. 3 is an explanatory view schematically illustrating a first section;

FIG. 4 is a perspective view schematically illustrating a chamber;

FIG. 5 is a plan view illustrating a coating die and a chamber as viewed from a support;

FIG. 6A to FIG. 6D are explanatory views schematically illustrating a coating film in each process included in a porous film production method, in which FIG. 6A is an explanatory view schematically illustrating the coating film in a film forming process, FIG. 6B is an explanatory view schematically illustrating the coating film in a wet air contacting process, and FIGS. 6C and 6D are explanatory views schematically illustrating the coating film in a drying process;

FIG. 7 is an explanatory view schematically illustrating a second embodiment of the present invention; and

FIG. 8 is an explanatory view schematically illustrating a third embodiment of the present invention.

### DESCRIPTION OF THE PREFERRED EMBODIMENTS

Hereinafter, preferred embodiments of the present invention are described in detail. However, the present invention is not limited thereto.

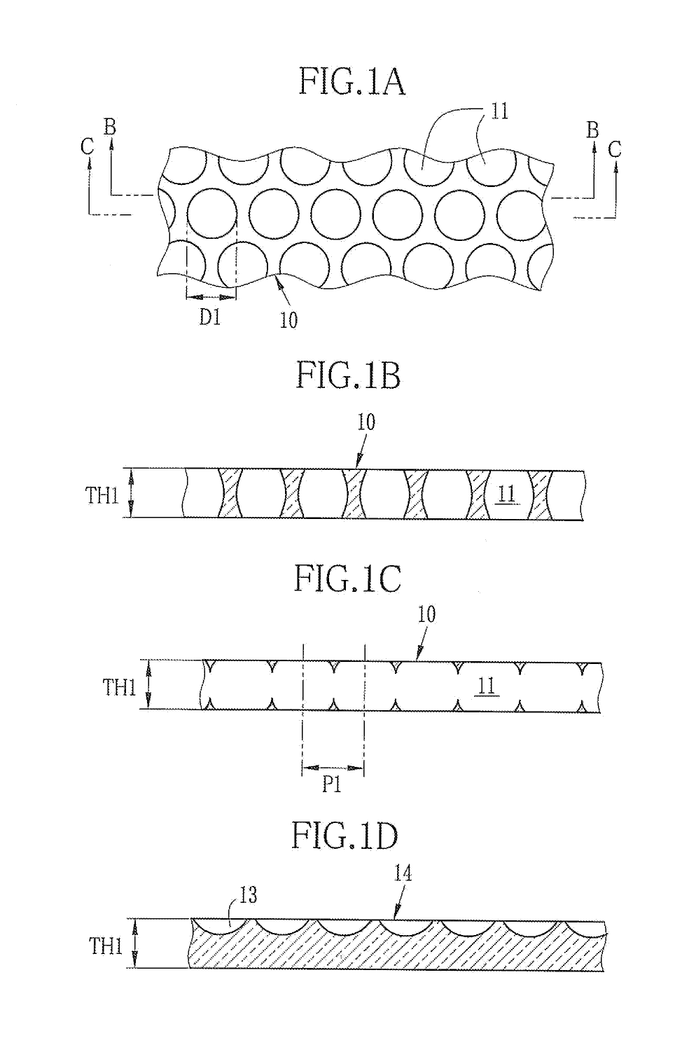

As shown in FIG. 1A, pores 11 are formed in a surface of a porous film 10 of the present invention. The pores 11 are densely arranged in the porous film 10 so as to constitute a honeycomb structure. As shown in FIGS. 1B and 1C, the pores 11 are formed so as to penetrate through both surfaces of the porous film 10. Note that, a porous film 14 having dimples 13 formed on one surface thereof instead of the pores 11 as shown in FIG. 1D, and a porous film in which the adjacent pores 11 are not interconnected with each other are also included in the porous film of the present invention.

In the present specification, the honeycomb structure means a structure in which the pores each having a specific shape and size are arranged regularly in a direction as described above. The regular arrangement of the pores is two dimensional in a case where the porous film is a single-layer film, and three dimensional in a case where the porous film is a multi-layer film. In the two dimensional arrangement of the pores, one pore is surrounded by plural (for example, 6) pores. In the three dimensional arrangement of the pores, the pores are filled most densely in a face-centered cubic structure or a hexagonal structure in many cases. However, in some production conditions, the other arrangements are made. Note that the number of pores formed around one pore on the same plane is not limited to six, and may be three to five, or seven or more.

The size and density of the pores 11 vary in accordance with the production conditions described later. The configuration of the porous film 10 of the present invention is not especially limited. However, in the present invention, for example, a thickness TH1 of the porous film 10 is preferably in a range of 0.05 μm to 10 μm, more preferably in a range of 0.05 μm to 5 μm, and most preferably in a range of 0.1 μm to 3 μm. A diameter D1 of the pore 11 is preferably in a range of 0.05 μm to 3 μm, more preferably in a range of 0.1 μm to 2 μm, and most preferably in a range of 0.1 μm to 1 μm. A pitch P1 of the pores 11 (distance between the centers of the adjacent pores 11) is preferably in a range of 0.1 μm to 10 μm, more preferably in a range of 0.1 μm to 5 μm, and most preferably in a range of 0.1 μm to 3 μm.

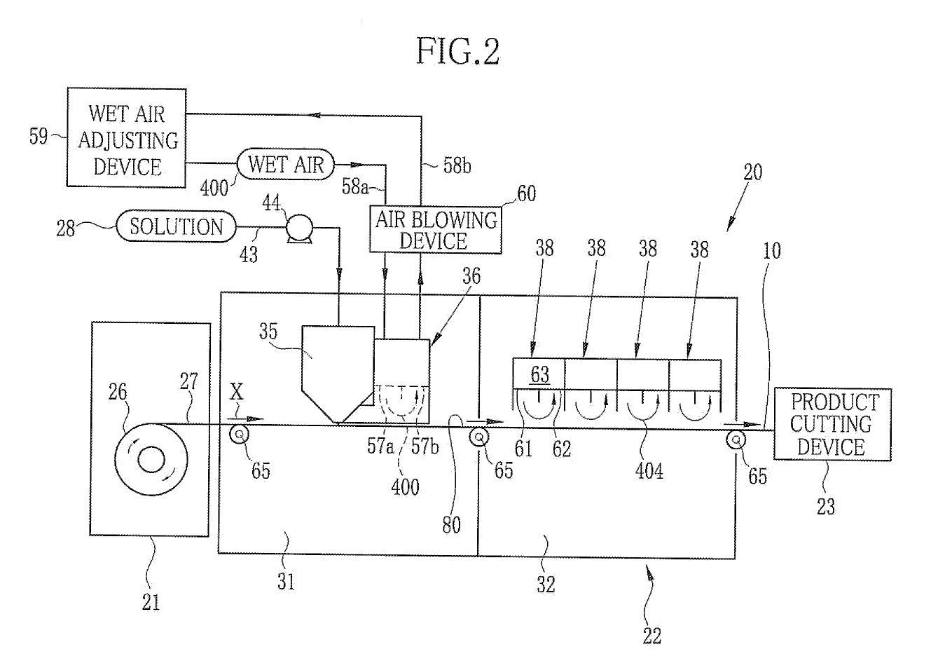

As shown in FIG. 2, a porous film production apparatus 20 of the present invention consists of a support feeding device 21, a coating room 22, and a product cutting device 23. A long support 27 is drawn from a support roll 26 and fed from the support feeding device 21 to the coating room 22. Note that the support 27 can be used as a base material of a porous film having plural layers. A solution 28 is applied to the support 27 and dried to be a porous film 10 in the coating room 22. The obtained porous film 10 is cut together with the support 27 by the product cutting device 23 to be an intermediate product having a predetermined size. The intermediate product is subjected to various kinds of processing to be a final product. The support 27 is a plate made of stainless, glass, or polymer. Note that the support feeding device 21 and the product cutting device 23 are used in the case of continuous mass production of the porous film 10, and may be appropriately omitted in accordance with the production scale.

The coating room 22 is partitioned into a first section 31 and a second section 32 in this order from an upstream side in a moving direction of the support 27. Hereinafter, the moving direction of the support 27 is referred to as X direction. The first section 31 includes a coating die 35 and a chamber 36 disposed in this order from the upstream side in the X direction. The second section 32 includes air feeding/sucking units 38. The chamber 36 and the coating die 35 may be formed to be integrated together.

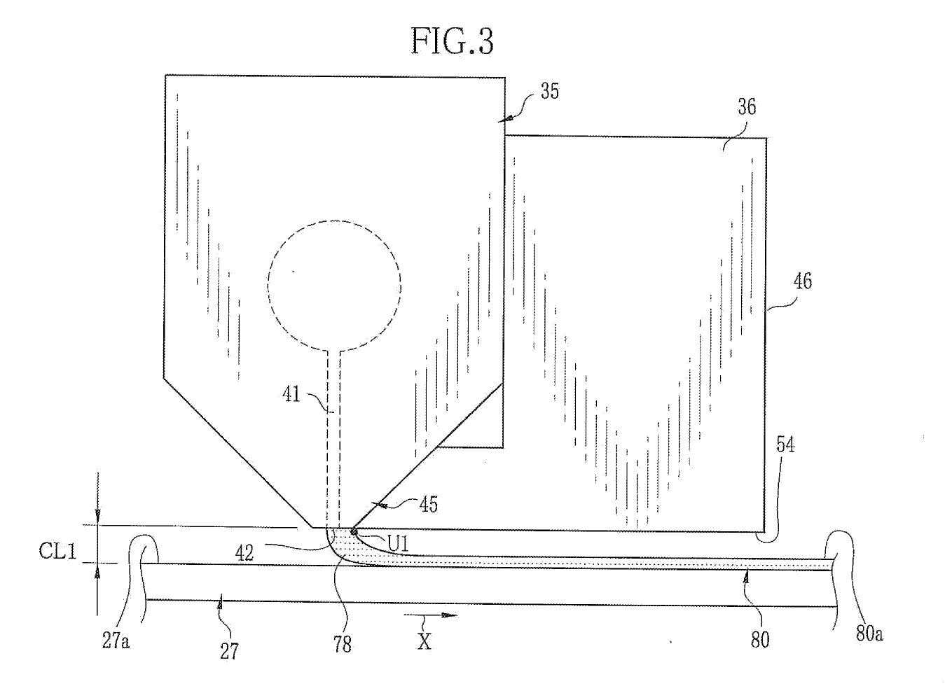

As shown in FIGS. 2 and 3, the coating die 35 has a slit 41 and a discharge port 42, and the slit 41 is communicated with a tank (not shown) for storing the solution 28 through a pipe 43. The pipe 43 is provided with a pump 44. The slit 41 has the discharge port 42 at the end. The coating die 35 is disposed such that the discharge port 42 faces the support 27. A clearance between the discharge port 42 of the casting die 35 and a surface 27a of the support 27 is denoted by CL1. The coating die 35 is preferably disposed such that the clearance CL1 is in a range of 0.01 mm to 1 mm. Note that the coating die 35 may be provided with a temperature adjuster so as to adjust a temperature of the solution 28 passing through the slit 41 to a predetermined range. Alternatively, the temperature of respective components of the coating die 35, such as a lip end 45, may be adjusted such that water vapor is not condensed from ambient air on the lip end 45.

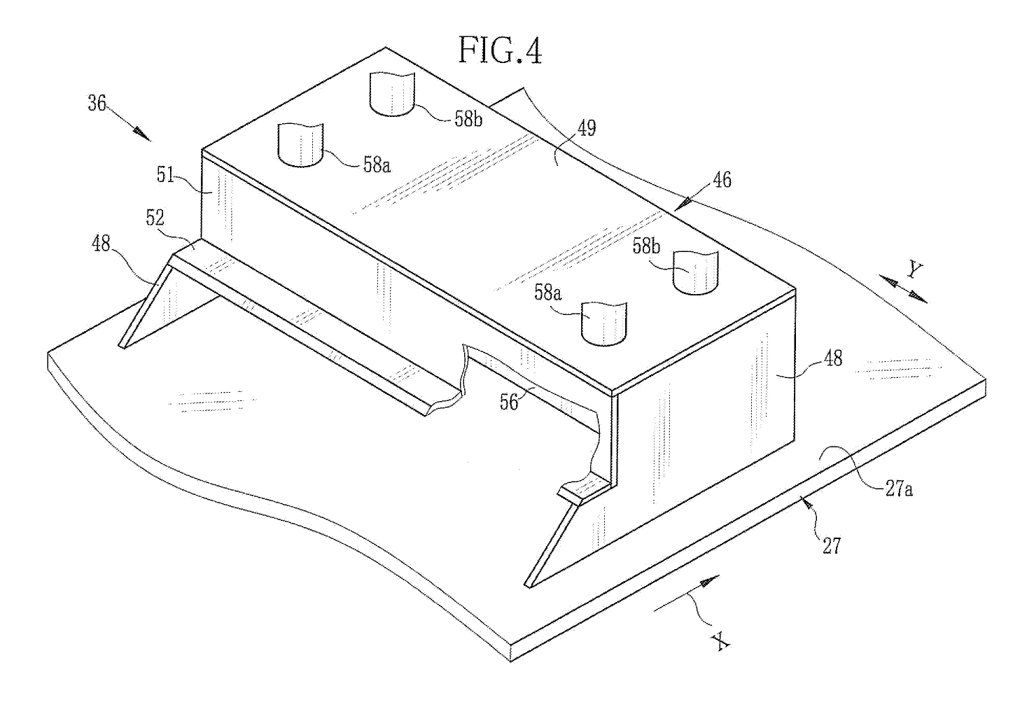

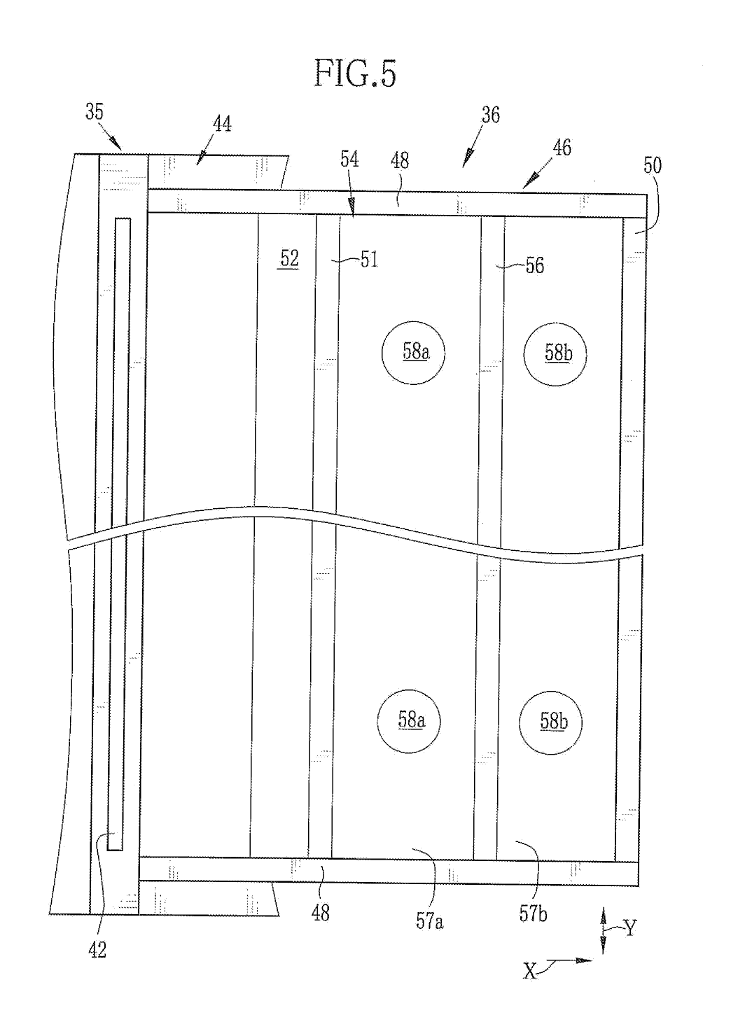

As shown in FIGS. 4 and 5, the chamber 36 is composed of a casing 46. The casing 46 consists of a pair of lateral plates 48 disposed in the X direction, a top plate 49 bridged over the pair of lateral plates 48, a first front plate 51, a second front plate 52, and a rear plate 50, such that the inside of the casing 46 is the cavity. The plates 48 to 52 are preferably made of a material which is not easily dissolved into an organic solvent. The plates 48 to 52 are made of stainless steel in this embodiment.

As shown in FIGS. 3 and 5, an opening 54 which is communicated with the cavity of the casing 46 is provided at the bottom of the casing 46 so as to be close to the support 27. Note that the opening 54 is preferably provided adjacent to the discharge port 42 in a downstream side from the discharge port 42 in the X direction.

As shown in FIGS. 4 and 5, a partition plate 56 is provided in a width direction of the support 27 (hereinafter referred to as Y direction) in the casing 46. The partition plate 56 is fixed to the casing 46. The partition plate 56 is preferably made of a material which is not easily dissolved into an organic solvent, and in particular, a material which is the same as that of the plates 48 to 52. The inside of the casing 46 is partitioned into a first cavity 57a and a second cavity 57b in this order from the upstream side in the X direction by the partition plate 56.

Pipes 58a and 58b are provided such that each of the pipes 58a and 58b is inserted into its corresponding hole formed on the top plate 49. The pipe 58a is communicated with the first cavity 57a, and the pipe 58b is communicated with the second cavity 57b. As shown in FIG. 2, a wet air adjusting device 59 for feeding wet air 400 is connected to the chamber 36 by the pipes 58a and 58b. An air blowing device 60 is provided to the pipes 58a and 58b. The wet air adjusting device 59 adjusts conditions such as a temperature and a dew point TD of the wet air 400, and a condensation point TR at which condensation of the solvent vapor starts. The air blowing device 60 feeds a predetermined flow volume of the adjusted wet air 400 to the first cavity 57a through the pipe 58a, and sends the wet air 400 and the like recovered through the second cavity 57b to the wet air adjusting device 59 through the pipe 58b.

Four air feeding/sucking units 38 are arranged in a line in the X direction in the second section 32. Each of the air feeding/sucking units 38 is provided with a duct having an outlet 61 and an inlet 62, and a blower 63. The temperature, humidity, dew point, and flow volume of dry air 404 to be fed through the outlet 61 are controlled by the blower 63. The gas around the coating film is sucked through the inlet 62. Note that the number of the air feeding/sucking units 38 to be disposed in the second section 32 is not limited to four, and may be one, two, three, or five or more.

A plurality of rollers 65 are appropriately disposed in each of the sections 31 and 32. Only main rollers 65 are shown and other rollers 65 are omitted in the drawing. The rollers 65 include driving rollers and free rotating rollers. The driving rollers are appropriately provided such that the support 27 is conveyed at a constant speed in each of the sections 31 and 32. The temperature of the rollers 65 is controlled by a temperature controller (not shown) independently in each of the sections 31 and 32. Additionally, between the adjacent rollers 65, a temperature controlling plate (not shown) is disposed near a surface reverse to the surface 27a (see FIG. 3) of the support 27. The temperature of the temperature controlling plate is adjusted such that the surface 27a of the support 27 has a temperature within a predetermined range.

Each of the sections 31 and 32 of the coating room 22 is provided with a solvent vapor recovering device (not shown) for recovering the solvent vapor contained in an atmosphere in each of the sections 31 and 32. The recovered solvent vapor is refined by a refining device (not shown) to be reused.

Next, a porous film production method performed by the porous film production apparatus 20 (see FIG. 2) is described hereinbelow. The rollers 65 are driven to rotate such that the support 27 is fed to the coating room 22 from the support feeding device 21. The temperature of the surface 27a of the support 27 is kept approximately constant within a predetermined range (within a range of 0° C. to 30° C.) by the temperature controlling plate (not shown). The support 27 sequentially passes through the first section 31 and the second section 32 at a predetermined speed (within the range of 0.001 m/min to 10 m/min). The pump 44 is used to feed a predetermined flow volume of the solution 28 whose temperature is adjusted so as to be approximately constant within a predetermined range (within a range of 0° C. to 30° C.) to the coating die 35 from the tank (not shown). The air blowing device 60 feeds a predetermined flow volume of the wet air 400 whose temperature, humidity, and the like are adjusted to a predetermined range to the chamber 36.

(Discharging Process)

As shown in FIG. 3, in a discharging process, the solution 28 is discharged through the discharge port 42 of the coating die 35 toward the surface 27a of the support 27. The discharged solution 28 passes through a clearance between the coating die 35 and the surface 27a to form a bead 78 extending from the discharge port 42 to the surface 27a.

(Wet Air Contacting Process)

As shown in FIGS. 2 and 3, in a wet air contacting process, the adjusted wet air 400 is blown through the first cavity 57a of the chamber 36 toward a downstream-side surface of the bead 78 in the X direction. The wet air 400 and the like around the bead 78 are recovered through the second cavity 57b of the chamber 36. The wet air 400 is caused to contact with the bead 78 such that water vapor is condensed from ambient air on the surface of the bead 78. Thereby, water drops are generated on the downstream-side surface of the bead 78 in the X direction.

(Film Forming Process)

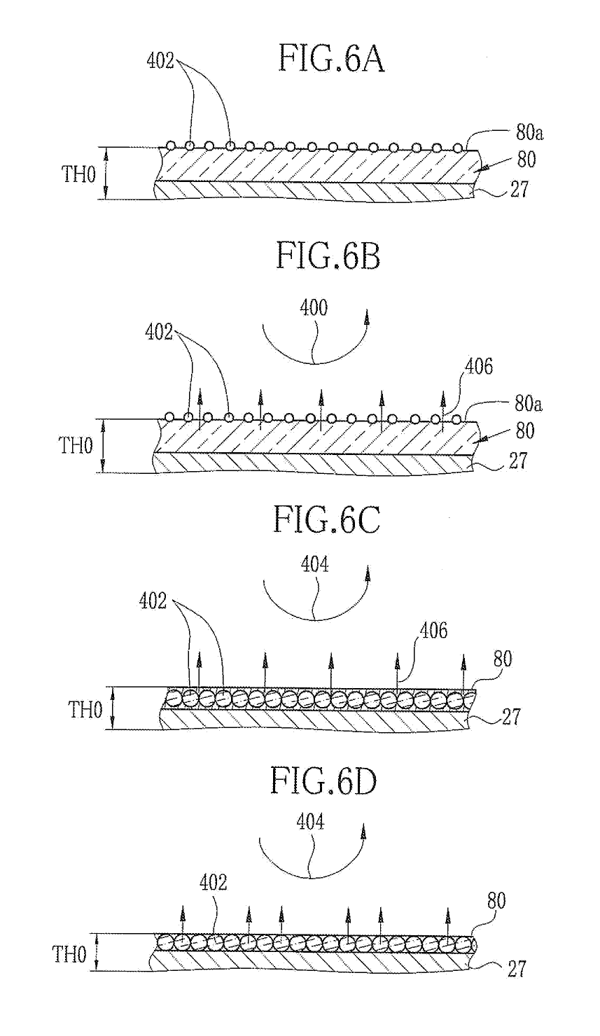

In a film forming process, as shown in FIGS. 2 and 6A, a coating film 80 is formed on the support 27. The coating film 80 is formed from the solution 28. The coating film 80 has water drops 402 generated during the wet air contacting process on its surface 80a. Subsequently, the adjusted wet air 400 is blown to the coating film 80 from the chamber 36. As shown in FIGS. 2 and 6B, the wet air 400 is caused to contact with the coating film 80 such that the water drops 402 on the surface 80a are grown up. As a result of capillary force and the like exerted on the water drops 402 on the surface 80a, the arrangement of the water drops 402 on the surface 80a exhibits a honeycomb structure. A thickness TH0 of the coating film 80 can be adjusted by the viscosity and flow volume of the solution 28, a clearance of the slit 41 (see FIG. 3), the moving speed of the support 27, and the like. The thickness TH0 is preferably at most 400 μm, more preferably at most 200 μm, and most preferably at most 100 μm. Note that, in order to form the coating film 80 having the uniform thickness TH0, the thickness TH0 is preferably at least 10 μm.

The amount and the growth degree of cores of the water drops 402 can be controlled by appropriately adjusting the parameter ΔTw obtained by subtracting TS from TD, in which TD is the dew point of the wet air 400 and TS is the temperature of the surface 80a of the coating film 80. The temperature TS can be adjusted by the temperature of the surface 27a of the support 27, the temperature of the solution 28, and the like. From the viewpoint of causing condensation, the parameter ΔTw in the first section 31 is preferably at least 0° C. Concretely, the parameter ΔTw is preferably in a range of 0.5° C. to 30° C., more preferably in a range of 1° C. to 25° C., and most preferably in a range of 1° C. to 20° C.

(Drying Process)

As shown in FIGS. 2 and 6C, the dry air 404 adjusted under a predetermined condition is blown from the air feeding/sucking units 38 to the coating film 80 as a primary form of the porous film 10 such that the dry air 404 is caused to contact with the coating film 80. Thereby, a solvent 406 is evaporated from the coating film 80. In accordance with the evaporation of the solvent 406 from the coating film 80, the fluidity of the solution 28 for forming the coating film 80 is decreased. As a result, the growth of the water drops 402 is stopped, and the coating film 80 becomes the primary form of the porous film 10 using the water drops 402 as the template for a porous film.

Then, as shown in FIGS. 2 and 6D, the dry air 404 adjusted under a predetermined condition is blown from the air feeding/sucking units 38 to the coating film 80 as a primary form of the porous film 10 such that the dry air 404 is caused to contact with the coating film 80. Thereby, the water drops 402 are evaporated from the coating film 80. Note that the water drops 402 and the solvent 406 may be evaporated from the coating film 80 at the same time. As a result, due to the evaporation of the water drops 402 and the like from the coating film 80, the porous film 10 can be obtained.

Further, in order to evaporate the solvent 406 from the coating film 80, it is also possible to adjust a parameter ΔTsolv obtained by subtracting TR from TA within a predetermined range, in which the TR denotes a condensation point of the dry air 404, and the TA denotes an atmospheric temperature around the coating film 80. The atmospheric temperature TA can be adjusted by the temperature of the dry air 404. The condensation point TR can be adjusted by using the solvent recovering device (not shown). For example, ΔTsolv is preferably more than 0° C. Further, it is also possible to accelerate the evaporation of the solvent 406 from the coating film 80 by heating the coating film 80. The coating film 80 can be heated by heating the support 27.

The solution 28 from the discharge port 42 of the casting die 35 to the support 27 has the free surface. According to the present invention, the wet air 400 is caused to contact with the solution 28 having the free surface. Namely, the wet air 400 is caused to contact with the solution 28 which has not reached the support 27 to be the coating film 80 yet. Therefore, it is possible to generate the water drops 402 on the free surface of the solution 28 before disturbance inducing troubles such as variation in size and density of the pores in the porous film 10 (hereinafter referred to as variation trouble) occur or before the disturbance increases. As the disturbance inducing the variation trouble, there are variation in the viscosity of the solution 28, convection of the solution 28, thickness unevenness of a bead 78, variation in the humidity of the atmosphere at the vicinity of the free surface, unevenness in evaporation of the solvent 28 on the free surface, convection of the atmosphere at the vicinity of the free surface, change in the proportion between the moving speed of the support 27 and the discharge amount of the solution 28, and the like. Thereby, according to the present invention, it is possible to produce the porous film in which the pores having a specific size are arranged such that the density thereof is uniform, while preventing the variation trouble caused by the disturbance more in comparison with the conventional methods.

The size of the water drops 402 may be controlled by adjusting the parameter ΔTsolv as well as the parameter ΔTw in the present invention. Namely, the wet air 400 in which each of the parameters ΔTsolv and ΔTw is adjusted to a predetermined range is caused to contact with the discharged solution 28, and thereby the water drops 402 are generated on the surface of the bead 78. While the water drops 402 are grown up, the solvent 406 may be actively evaporated from the solution 28. Decrease in the fluidity of the solution 28 due to the evaporation of the solvent 406 may be utilized in order to prevent the growth of cores of the water drops 402. Note that the condition of the parameter ΔTsolv in the wet air 400 may be the same as that of the parameter ΔTsolv in the dry air 404 described above.

As an indication whether or not the level of fluidity of the solution 28 is sufficient to prevent the growth of cores of the water drops 402, viscosity and composition of the solution 28, remaining amount of the solvent in the solution 28, and the like can be utilized. Among them, the viscosity of the solution 28 and the remaining amount of the solvent in the solution 28 are utilized as the preferable indication. The range of the viscosity of the solution 28 and the range of the remaining amount of the solvent in the solution 28 as the indication depend on the composition of the used solution 28 or the like. However, for example, it is preferable that the wet air 400 is caused to contact with the solution 28 such that the viscosity of the solution 28 becomes 10 Pa·s or less, or the remaining amount of solvent in the solution 28 becomes 500 wt % or less, until the size of the water drops 402 achieves the target value. Here, the remaining amount of the solvent in the solution 28 is the amount of the solvent remaining in the solution 28 or the coating film 80 on a dry basis. The remaining amount of the solvent is calculated by a formula expressed by [(x−y)/y]×100, in which x is the weight of a sampling solution or a sampling film at the time of sampling, and y is the weight of the same after being dried completely. The sampling solution or the sampling film is taken from a target solution or film.

Note that in a case where the target size of the water drops 402 is extremely small, the wet air 400 is caused to contact with the solution 28, under the condition that the time required for decreasing the fluidity of the discharged solution 28 enough to prevent the growth of cores of the water drops 402 is preferably within 30 seconds, more preferably within 20 seconds, and most preferably within 10 seconds.

As described above, according to the present invention, the amount and the growth degree of cores of the water drops 402 are controlled by causing the wet air 400 in which the parameters ΔTsolv and ΔTw are adjusted to contact with the solution 28. Simultaneously, the solvent 406 is evaporated from the solution 28 such that the growth of cores of the water drops 402 is prevented by utilizing the decrease in fluidity of the solution 28 due to the evaporation of the solvent 406. Therefore, it is possible to prevent the growth of cores of the water drops 402 at the time when the size of the water drops 402 achieves the target value. Thereby, according to the present invention, it is possible to readily produce the porous film having pores whose size is a target value.

Although the wet air 400 is blown to the solution 28 discharged from the coating die 35 in the above embodiment, the present invention is not limited thereto. It is also possible to cause the wet air 400 to contact with the solution 28 such that the water drops 402 are generated on the free surface of the solution 28 or the surface 80a of the coating film 80. It is preferable that the wet air 400 is caused to contact with the solution 28 at the same time of formation of the free surface of the solution 28. Namely, it is preferable that the wet air 400 is caused to contact with an upstream end U1 (see FIG. 3) of the free surface of the solution 28. More preferably, the wet air 400 is continuously caused to contact with the discharged solution 28 until the solution 28 reaches the support 27 to be the coating film 80 thereon. Alternatively, it is also possible to discharge the solution 28 to the first section 31 filled with the wet air 400. Note that not only the generation of the water drops 402 but also growth of the water drops 402 or evaporation of the solvent 406 may be conducted by causing the wet air 400 to contact with the solution 28.

Additionally, although the wet air 400 is blown from the upstream side to the downstream side in the X direction in the above embodiment, the present invention is not limited thereto. The wet air 400 may be blown from the downstream side to the upstream side in the X direction.

Note that although the opening 54 of the chamber 36 is partitioned into the first section 57a and the second section 57b in this order from the upstream side in the X direction in the above embodiment, the present invention is not limited thereto. Alternatively, a plurality of opening pairs including a first opening and a second opening may be disposed in the chamber 36. The wet air 400 whose condition is different from each other for each opening pair may be fed to the solution 28 or the coating film 80 such that the wet air contacting process whose condition is different from each other for each opening pair is performed. Alternatively, the wet air contacting process and the drying process may be sequentially performed in the chamber 36. When the wet air contacting process and the drying process are performed in the chamber 36, the second section 32 may be omitted.

Although the coating die is used for application of the solution in the above embodiment, the present invention is not limited thereto. Well-known coating methods such as slide coating, gravure coating, bar coating, and roller coating also may be utilized in the present invention. Among them, the coating die is most preferably used because of the following reason. When a solution stored in a container in an air-tight state is discharged, it is possible to form the free surface of the discharged solution, apply the discharged solution to the support, and cause the wet air 400 to contact with the discharged solution approximately simultaneously by using the coating die.

As shown in FIG. 2, although the porous film 10 is cut together with the support 27 to have a predetermined size by the product cutting device 23 in the above embodiment, the present invention is not limited thereto. For example, in a case where the support 27 is an endless belt or drum made of stainless, or other polymer film, which endlessly passes through the first section 31 and the second section 32 subsequently, the porous film 10 may be peeled from the support 27 and then introduced into the product cutting device 23. Further, in the case of low-volume production, a cut sheet may be used instead of the support 27.

(Solution)

The solution 28 contains the solvent and the polymer which is dissolved into the solvent uniformly. The concentration of the polymer in the solution 28 is sufficient as long as the coating film 80 having a uniform thickness is formed on the surface 27a of the support 27. For example, the concentration of the polymer in the solution 28 is preferably in a range between 0.01 mass % or more and 30 mass % or less. When the concentration of the polymer is less than 0.01 mass %, the productivity of the film is low, and therefore may be unsuitable for industrial mass production in some cases. In contrast, when the concentration of the polymer is more than 30 mass %, the viscosity of the solution 28 is increased, and thereby it may be difficult to form the coating film 80.

The viscosity of the solution 28 is preferably in a range between 1×10⁻⁴ Pa·s or more and 1×10⁻¹ Pa·s or less. In a case where the viscosity of the solution 28 is more than 1×10⁻¹ Pa·s, the low fluidity of the solution 28 results in difficulty in arrangement of the water drops 402 on the coating film. Thereby, variation in the pore pitch may occur, unfavorably. In contrast, in a case where the viscosity of the solution 28 is less than 1×10⁻⁴ Pa·s, the high fluidity of the solution 28 results in formation of water drops interconnected with each other. Thereby, variation in the size of the pores may occur, unfavorably.

Interfacial tension between the solution 28 and the water is preferably in a range between 5 mN/m or more and 20 mN/m or less. In a case where the interfacial tension between the solution 28 and the water is more than 20 mN/m, it becomes difficult to form minuscule water drops on the surface of the solution 28, unfavorably. In contrast, in a case where the interfacial tension between the solution 28 and the water is less than 5 mN/m, the water drops are fused with each other during its growth process to cause variation in size of the pores, unfavorably.

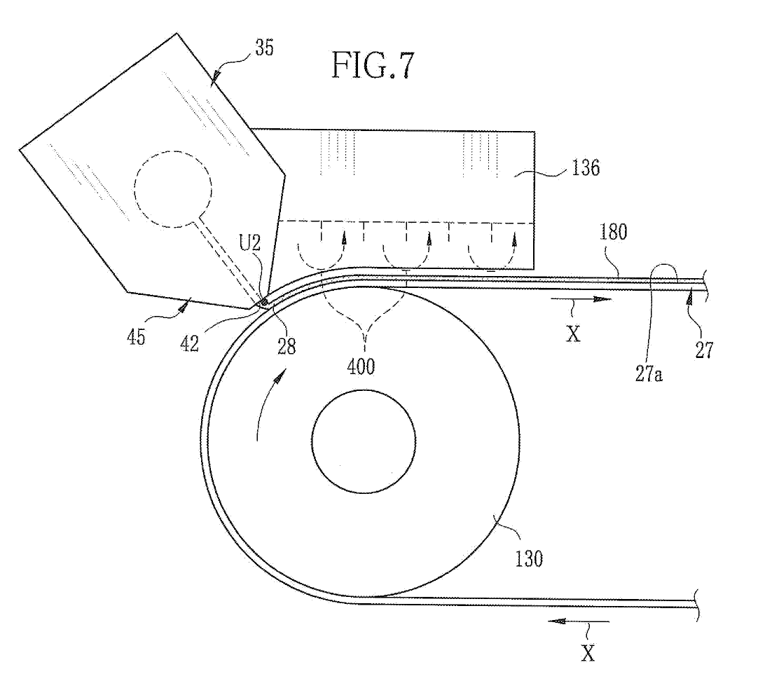

A second embodiment of the present invention is described hereinbelow. Note that the components and devices identical to those in FIGS. 2 and 3 are denoted by the same reference numerals, and the detailed description thereof will be omitted. As shown in FIG. 7, the support 27 is wrapped over a roller 130. The coating die 35 is disposed such that a portion of the surface 27a of the support 27 which is wrapped over the roller 130 faces the discharge port 42. The chamber 136 is disposed in the downstream side from the coating die 35 in the X direction. As in the case of the chamber 36, the chamber 136 includes a first cavity and a second cavity. The wet air 400 can be blown to the bead that is formed from the coating die 35 to the surface 27a through the first cavity of the chamber 136. It is preferable that the wet air 400 is caused to contact with an upstream end U2 (see FIG. 7) of the bead, and it is more preferable that the wet air 400 is continuously caused to contact with the bead until the bead reaches the support 27 to be a coating film 180 thereon. The wet air 400 is caused to contact with the solution 28, and thereby water vapor is condensed from ambient air on the free surface of the solution 28 to generate water drops. Accordingly, it is possible to form a coating film 180, which is formed from the solution 28 and has a surface on which the water drops are generated, on the surface 27a of the support 27.

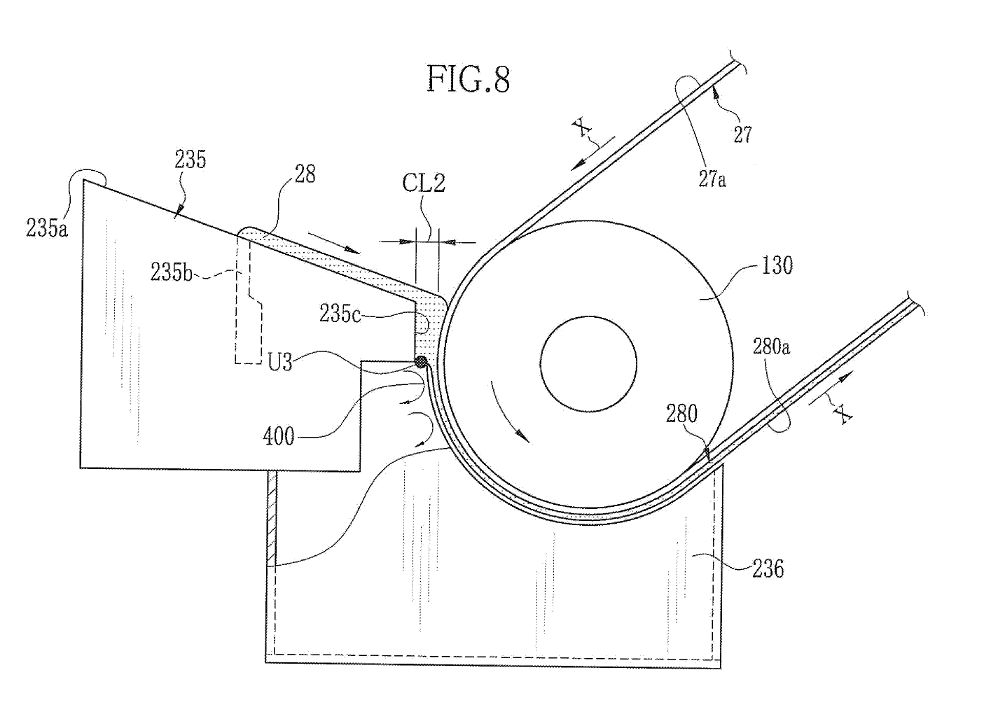

A third embodiment of the present invention is described hereinbelow. As shown in FIG. 8, a coating die 235 and a chamber 236 are disposed in this order from an upstream side in the X direction near a portion of the surface 27a of the support 27 which is wrapped over the roller 130. An upper surface of the coating die 235 is a sliding surface 235a. Inside the coating die 235 is provided a slit 235b. An outlet of the slit 235b is exposed outside through the sliding surface 235a. The sliding surface 235a is inclined such that a height of the sliding surface 235a is decreased toward the roller 130. A surface of the coating die 235, which faces the roller 130, is a liquid-contact surface 235c. A clearance between the liquid-contact surface 235c and the surface 27a is denoted by CL2. The range of the CL2 is preferably approximately equal to that of the CL1 described above. As in the case of the chamber 36, the chamber 236 includes a first cavity and a second cavity provided in this order from the upstream in the X direction, such that the first cavity is provided in the downstream side from the liquid-contact surface 235c in the X direction.

The solution 28 supplied to the coating die 235 is discharged onto the sliding surface 235a through the slit 235b. The solution 28 on the sliding surface 235a is flown toward the moving support 27. The solution 28 passes through a clearance between the liquid-contact surface 235c and the surface 27a to have a free surface. The wet air 400 can be blown to the free surface of the solution 28 from the chamber 236. In particular, it is preferable that the wet air 400 is caused to contact with an upstream end U3 (see FIG. 8) of the free surface of the solution 28 from the chamber 236, and it is more preferable that the wet air 400 is continuously caused to contact with the discharged solution 28 until the solution 28 reaches the support 27 to be a coating film 280 thereon. The wet air 400 is caused to contact with the free surface of the solution 28, and thereby water vapor is condensed from ambient air on the free surface of the solution 28 to generate water drops. Accordingly, it is possible to form the coating film 280, which is formed from the solution 28 and has a surface 280a on which the water drops are generated, on the surface 27a of the support 27.

The present invention is not limited to this embodiment shown in FIG. 8. For example, in FIG. 8, while the location of each of the coating die 235 and the roller 130 is not changed, the moving direction of the support 27 is changed to a reverse direction, and the chamber 236 is disposed in the downstream side from the coating die 235 in the moving direction of the support 27. In this case, it is possible to blow the wet air 400 from the chamber 236 toward the solution 28 just after being discharged from the coating die 235, namely, the solution 28 before being the bead.

(Solvent)

The solvent is an organic solvent or the like, and is not especially limited as long as it has a hydrophobic character and can dissolve the polymer. Examples of the solvent are chloroform, dichloromethane, carbon tetrachloride, cyclohexane, methyl acetate, and the like. Additionally, a hydrophilic solvent such as alcohol, ketone, or the like may be added to the hydrophobic solvent. The additive amount of the hydrophilic solvent is preferably at most 20 wt %.

(Polymer)

The polymer to be used is preferably dissolved into a water-insoluble solvent (hereinafter the polymer is referred to as hydrophobic polymer). Moreover, although only the hydrophobic polymer is sufficient to form the porous film, it is preferable that an amphiphilic polymer is used together with hydrophobic polymer.

(Hydrophobic Polymer)

The hydrophobic polymer is not especially limited, and may be appropriately selected among well-known hydrophobic polymers in accordance with the purpose. Examples of the hydrophobic polymers are vinyl-type polymer (for example, polyethylene, polypropylene, polystyrene, polyacrylate, polymethacrylate, polyacrylamide, polymethacrylamide, polyvinyl chloride, polyvinylidene chloride, polyvinylidene fluoride, polyhexafluoropropene, polyvinyl ether, polyvinyl carbazol, polyvinyl acetate, polytetrafluoroethylene, and the like), polyester (for example, polyethylene terephthalate, polyethylene naphthalate, polyethylene succinate, polybutylene succinate, polylactic acid, and the like), polylactone (for example, polycaprolactone and the like), polyamide or polyimide (for example, nylon, polyamic acid, and the like), polyurethane, polyurea, polybutadiene, polycarbonate, polyaromatics, polysulfone, polyethersulfone, polysiloxane derivative, cellulose acylate (for example, triacetyl cellulose, cellulose acetate propionate, cellulose acetate butyrate, and the like), and the like. These may be used in the form of homo polymer, and otherwise used as copolymer, or polymer blend, in view of solubility, optical physical properties, electric physical properties, film strength, elasticity, and the like. Note that these polymers may be used in the form of mixture containing two or more kinds of polymers as necessary. The polymers for optical purpose are preferably cellulose acylate, cyclic polyolefin, and the like.

(Amphiphilic Polymer)

The amphiphilic polymer is not especially limited, and appropriately selected in accordance with the purpose. For example, there are an amphiphilic polymer which has a main chain of polyacrylamide, a hydrophobic side chain of dodecyl group, and a hydrophilic side chain of carboxyl group, a block copolymer of polyethylene glycol/polypropylene glycol, and the like.

The hydrophobic side chain is a group which has nonpolar normal (linear) chain such as alkylene group, phenylene group, and the like, and preferably has a structure in which a hydrophilic group such as polar group or ionic dissociative group is not divided until the end of the chain, except a linking group such as ester group and amide group. The hydrophobic side chain preferably has at least five methylene units if it is composed of alkylene group. The hydrophilic side chain preferably has a structure having a hydrophilic part such as polar group, ionic dissociative group, or oxyethylene group on the end through a linking part such as alkylene group.

The ratio of the hydrophobic side chain to the hydrophilic side chain varies depending on the size and nonpolarity of the side chain, the intensity of polarity, the strength of hydrophobicity of a hydrophobic organic solvent, or the like, and cannot be specified in general. However, the unit ratio (hydrophilic side chain: hydrophobic side chain) is preferably in the range of 0.1:9.9 to 4.5:5.5. Further, in the case of a copolymer, a block copolymer, in which the hydrophobic side chain and the hydrophilic side chain form a block such that the solubility thereof in the hydrophobic solvent is not affected, is preferable rather than an alternating polymer of a hydrophobic side chain and a hydrophilic side chain.

The number average molecular weight (Mn) of the hydrophobic polymer and the amphiphilic polymer is preferably in the range of 1,000 to 10,000,000, and more preferably in the range of 5,000 to 1,000,000.

The composition ratio (mass ratio) of the hydrophobic polymer and the amphiphilic polymer is preferably in a range of 99:1 to 50:50, and more preferably in range of 98:2 to 70:30. In a case where the ratio of the amphiphilic polymer is less than 1 mass %, a porous film in which the sizes of the pores are uniform cannot be obtained in some cases. In contrast, in a case where the ratio of the amphiphilic polymer is more than 50 mass %, stability of the coating film, in particular, mechanical stability thereof cannot be obtained sufficiently in some cases.

It is also preferable that the hydrophobic polymer and the amphiphilic polymer to be used as raw materials of a porous film are a polymerizable (crosslinkable) polymer having a polymerizable group in its molecule. Further, it is preferable that together with the hydrophobic polymer and/or the amphiphilic polymer, a polymerizable polyfunctional monomer is blended. After forming a honeycomb film by blending, the blended material may be cured by the well-known method such as a thermal curing method, a UV curing method, or an electron beam curing method from the viewpoint of improvement of strength of the porous film.

As the polyfunctional monomer that can be used together with the hydrophobic polymer and/or the amphiphilic polymer, a polyfunctional (meth)acrylate is preferable from the viewpoint of reactivity. As the polyfunctional (meth)acrylate, for example, there can be used dipentaerythritol pentaacrylate, dipentaerythritol hexaacrylate, dipentaerythritol caprolactone adduct hexaacrylate or a modified compound thereof, an epoxy acrylate oligomer, a polyester acrylate oligomer, a urethane acrylate oligomer, N-vinyl-2-pyrrolidone, tripropylene glycol diacrylate, polyethylene glycol diacrylate, trimethylolpropane triacrylate, pentaerythritol triacrylate, pentaerythritol tetraacrylate or a modified compound thereof, and the like. These polyfunctional monomers are used alone or in combination of two or more types thereof from the viewpoint of the balance between resistance to abrasion and flexibility.

In a case where the hydrophobic polymer and the amphiphilic polymer are a polymerizable (crosslinkable) polymer having a polymerizable group in its molecule, it is also preferred to use a polymerizable polyfunctional monomer that can react with the polymerizable group of the hydrophobic polymer and the amphiphilic polymer in combination.

In the above polyfunctional monomers, the monomer having an ethylene type unsaturated group can be polymerized by irradiating of ionizing radiation or heating under the presence of a photoradical initiator or a thermal radical initiator. For instance, a coating liquid containing the monomer having the ethylene type unsaturated group, the photoradical initiator or the thermal radical initiator, matting particles, and inorganic filler is prepared. After the coating liquid is applied on a transparent support, it is cured by polymerization reaction caused by the ionizing radiation or heat, so that it is possible to produce a porous film which can be used as an antireflection film.

As the photoradical initiator, there are acetophenones, benzoins, benzophenones, phosphine oxides, ketals, anthraquinones, thioxanthones, azo compounds, peroxides, 2,3-alkyl dion compounds, disulfide compounds, fluoroamine compounds, and aromatic sulfoniums, for example.

As the acetophenones, there are 2,2-ethoxyacetophenone, p-methylacetophenone, 1-hydroxydimethyl phenyl ketone, 1-hydroxycyclohexyl phenyl ketone, 2-methyl-4-methylthio-2-morpholinopropiophenone, 2-benzyl-2-dimethylamino-1-(4-morpholinophenyl)-butanone, for example.

As the benzoins, there are benzoin benzenesulfonic ester, benzoin toluenesulfonic ester, benzoin methyl ether, benzoin ethyl ether, benzoin isopropyl ether, and the like, for example.

As the benzophenones, there are benzophenone, 2,4-chlorobenzophenone, 4,4-dichlorobenzophenone, p-chlorobenzophenone, and the like, for example.

As the phosphine oxides, there are 2,4,6-trimethylbenzoyl diphenylphosphine oxide and the like, for example.

Various examples of the photoradical initiator are described in “Saishin UV-Koka Gijutsu (Latest UV Curing Technologies)” (page 159, publisher: Kazuhiro TAKABO; publishing company: Technical Information Institute CO., LTD, 1991). As a preferable example of a commercially available photocleavage-type photoradical initiator, there is Irgacure (651,184,907) produced by Chiba Specialty Chemicals CO., Ltd (Ciba Japan K.K.).

The photoradical initiator is preferably used within a range of 0.1 to 15 parts by mass to 100 parts by mass of the polyfunctional monomer, and more preferably within a range of 1 to 10 parts by mass.

Note that a photosensitizer may be used in addition to the photoradical initiator. As the example of the photosensitizer, there are n-butylamine, triethylamine, tri-n-butylphosphine, Michler's ketone, thioxanthone, and the like.

As the thermal radical initiator, organic peroxide, inorganic peroxide, organic azo compound, organic diazo compound, and the like can be used, for example.

As the organic peroxide, there are benzoyl peroxide, halogen benzoyl peroxide, lauroyl peroxide, acetyl peroxide, dibutyl peroxide, cumene hydroperoxide, butyl hydroperoxide, and the like, for example. As the inorganic peroxide, there are hydrogen peroxide, ammonium persulfate, potassium persulfate, and the like, for example. As the azo compound, there are 2,2′-azobis (isobutyronitrile), 2,2′-azobis (propionitrile), 1,1′-azobis (cyclohexanecarbonitrile), and the like, for example. As the diazo compound, there are diazoaminobenzene, p-nitrobenzenediazonium, and the like, for example.

### EXAMPLE

### Example 1

The porous film 10 was formed from the solution 28 by the porous film production apparatus 20 shown in FIG. 2. The thickness TH0 of the coating film 80 was 100 μm.

### Example 2

The porous film 10 was formed from the solution 28 in the same manner as that of Example 1 except that the chamber 136 shown in FIG. 7 was used instead of the chamber 36 shown in FIG. 2. The thickness TH0 of the coating film 80 was 50 μm.

### Comparative Experiment 1

The coating die 35 and the chamber 36 were disposed so as to be away from each other such that the wet air was not caused to contact with the discharged solution 28 between the coating die 35 and the support 27. The clearance between the coating die 35 and the chamber 36 was adjusted by displacing the coating die 35. The clearance between the coating die 35 and the chamber 36 was set to 1000 mm by the displacement of the coating die 35. Other conditions were the same as those in Example 1. The thickness TH0 of the obtained porous film was 100 μm.

### Comparative Experiment 2

The coating die 35 and the chamber 36 were disposed so as to be away from each other such that the wet air was not caused to contact with the discharged solution 28 between the coating die 35 and the support 27. The clearance between the coating die 35 and the chamber 36 was set to 300 mm by the displacement of the coating die 35. Other conditions were the same as those in Example 1. The thickness TH0 of the obtained porous film was 100 μm.

1. Evaluation of Variation in Pore Diameters

Variation in pore diameters of the porous film obtained in each of the above examples and comparative examples was evaluated based on the following criteria. The diameters of the pores formed in the porous film are measured. A coefficient of variation is expressed by D/V, in which a standard deviation of pore diameters is denoted by D and an average pore diameter is denoted by V.

E (Excellent): Coefficient of variation was less than 10%.

P (Passed): Coefficient of variation was in a range between 10% or more and less than 15%.

F (False): Coefficient of variation was 15% or more.

2. Appearance Evaluation

The porous film obtained in each of the above examples and comparative examples was visually observed, and evaluated based on the following criteria.

P (Passed): No streaks and spiral unevenness occurred on a surface of the porous film.

F (False): Streaks and spiral unevenness occurred on the surface of the porous film.

In accordance with the evaluation results of the above evaluation items 1 and 2, comprehensive evaluation was made as follows. When both of the above evaluation items 1 and 2 were

P or E, the comprehensive evaluation was P. When at least one of the above evaluation items 1 and 2 was F, the comprehensive evaluation was F.

The evaluation results of the above evaluation items in the above examples and comparative examples are shown in Table 1. The numbers assigned to the evaluation items in Table 1 correspond to the numbers of the above evaluation items.

TABLE 1

| | Evaluation Result | | |
|---|---|---|---|
| | | | Comprehensive |
| | 1 | 2 | Evaluation |
| Example 1 | E | P | P |
| Example 2 | E | P | P |
| Comparative | F | F | F |
| Example 1 | | | |
| Comparative | P | F | F |
| Example 2 | | | |

In comparative examples 1 and 2 not satisfying the elements of the present invention, the coating die 35 and the chamber 36 were disposed so as to have a clearance therebetween, such that the wet air was not caused to contact with the upstream end of the free surface of the solution. Therefore, variation in pore diameters was caused, and streaks and spiral unevenness occurred on the surface of the obtained porous film. In contrast, in examples 1 and 2 satisfying the elements of the present invention, it was possible to form a porous film while preventing variation trouble.

Various changes and modifications are possible in the present invention and may be understood to be within the present invention.

What is claimed is:

1. A porous film production method comprising the steps of:
discharging a solution containing a polymer and a hydrophobic solvent onto a moving support by a discharge device;
causing wet air to contact with said discharged solution between said discharge device and said support, said solution reaching said support to be a film;
condensing water vapor from ambient air by the contact of said wet air and said solution to generate water drops; and
drying said film such that said film has pores made by said water drops as a template for a porous film.

2. A porous film production method as defined in claim 1, wherein said wet air is caused to contact with an upstream end of a free surface of said discharged solution between said discharge device and said support.

3. A porous film production method as defined in claim 1, wherein said solution is discharged in an atmosphere filled with said wet air.

4. A porous film production method as defined in claim 2, wherein said wet air is continuously caused to contact with said free surface of said solution until said solution becomes said film.

5. A porous film production method as defined in claim 1, wherein said discharge device is a coating die.

6. A porous film production apparatus comprising:
a moving support;
a discharge device for discharging a solution containing a polymer and a hydrophobic solvent onto said support, said solution reaching said support to be a film;
a wet air contacting device for causing wet air to contact with said discharged solution between said discharge device and said support; and
a drying device for drying said film whose surface has water drops generated by water vapor condensed from ambient air, such that said film has pores made by said water drops as a template for a porous film.

7. A porous film production apparatus as defined in claim 6, wherein
said discharge device has a die for discharging said solution onto said support, and
said wet air contacting device has a humidifying chamber disposed in a downstream side from said die in a moving direction of said support.
